(19) United States
(12) Patent Application Publication
(10) Pub. No.: US 2004/0011232 A1
(43) Pub. Date: Jan. 22, 2004

(54) Ink fountain assembly and method of dispensing ink

(76) Inventor: Thomas J. Gray, Milwaukee, WI (US)

Correspondence Address: QUARLES & BRADY LLP, 411 E. WISCONSIN AVENUE, SUITE 2040, MILWAUKEE, WI, 53202-4497, US

(21) Appl. No.: 10/197,064

(22) Filed: Jul. 16, 2002

(51) Int. Cl. B41F 31/00

(52) U.S. Cl. 101/350.1

(57) ABSTRACT

An ink fountain assembly having an ink fountain for receiving ink. The ink fountain is in fluid communication with a fountain roller, and has a minimum operating ink level. An ink dispenser for dispensing ink into the ink fountain has at least one exit port disposed below the minimum operating ink level, wherein ink exits the ink dispenser through the at least one exit port into the ink fountain.

### CROSS REFERENCES TO RELATED APPLICATIONS

Not Applicable

### STATEMENT REGARDING FEDERALLY SPONSORED RESEARCH

Not Applicable.

### BACKGROUND OF THE INVENTION

The present invention relates to a method and apparatus for distributing ink in a printing press ink fountain. In particular, a method and apparatus for distributing ink in a printing press ink fountain which eliminates mounding and skin formation.

One known printing press, typically includes a plate cylinder carrying a printing plate. The printing plate has oleophilic surfaces defining an image area, and hydrophilic surfaces defining a non-image area. Ink applied ink to the printing plate collects on the oleophilic surfaces to form an image which can be transferred to a blanket cylinder. The blanket cylinder transfers the image to media. By transferring the image from the printing plate onto a blanket roller, and then onto the media, the printing plate does not directly print the image on the media, hence the term offset printing.

An ink fountain assembly provides the ink which is carried on one or more form rollers to the printing plate from an ink fountain assembly. A typical ink fountain assembly 1, such as shown in FIG. 1 and 2, includes an open trough 2 and an ink dispenser 3. The elongated trough 3 having a bottom joined to a rear side wall and trough ends. A front side of the trough is blocked by a fountain roller 4 to form a reservoir. The fountain roller 4 rotates to draw ink 5 from the reservoir. The ink dispenser includes an ink valve 6 which controls the flow of ink through a manifold 7. The manifold 7 is disposed above the ink top surface, and dispenses the ink into the trough through one or more nozzles 8, or other openings formed in the manifold.

The ink used in printing presses tend to be thick and highly viscous. As a result, ink dispensed from the manifold tends to form mounds which slowly dissipates. As shown in FIGS. 1 and 2, an ink level sensor 9, such as disclosed in U.S. Pat. No. 5,103,728, can be provided to sense the level of the ink. Unfortunately, the mounding prevents an accurate reading of the actual level of ink in the trough which degrades the usefulness of the ink level reading from the sensor.

Ink dispensed from the manifold also has a tendency to dry and clog the manifold openings. In order to maintain the flow of ink into the trough, as required to maintain a quality printed product, the printing press must be stopped on a regular basis to clean out the openings. As a result, easy access to the manifolds must be maintained in order to perform the necessary maintenance. Downtime resulting from stopping the presses is expensive. Moreover, providing quick and easy access to the manifold precludes closing the top of the trough with a cover that must be removed for maintenance.

Finally, the ink in the trough tends to develop stagnant areas in which the ink does not circulate. As a result, ink in the stagnant areas will not circulate toward the fountain roller sooner than ink dispensed at a later time. A skin can form on the ink surface in the stagnant areas which can spoil the printed article if it is pulled out of the trough by the fountain roller. Agitators have been developed, such as disclosed in U.S. Pat. No. 3.848,529 and 4,768,438, which agitate the ink in the trough to prevent the skin formation. The agitators are mechanical devices which require maintenance and increases the printing press cost and complexity.

These above problems associated with prior art presses increase the cost of purchasing and operating the prior art presses. Accordingly, a need exists for an ink fountain assembly that eliminates mounding and skins, and does not require frequent downtime to unclog ink manifold openings.

### SUMMARY OF THE INVENTION

The present invention provides an ink fountain assembly having an ink fountain for receiving ink. The ink fountain is in fluid communication with a fountain roller, and has a minimum operating ink level. An ink dispenser for dispensing ink into the ink fountain has at least one exit port disposed below the minimum operating ink level, wherein ink exits the ink dispenser through the at least one exit port into the ink fountain.

A general objective of the present invention is to provide an ink fountain assembly which inhibits skin formation in the ink disposed in the ink fountain. This objective is accomplished by dispensing ink into the ink fountain, such that the dispensed ink circulates the ink disposed in the ink fountain to move the ink surface toward the fountain roller.

Another objective of the present invention is to provide an ink fountain assembly which does not cause the ink to mound in the ink fountain as the ink is dispensed. This objective is accomplished by dispensing the ink into the ink fountain below the surface of the ink in the ink fountain.

These and still other objectives and advantages of the present invention will be apparent from the description which follows. In the detailed description below, preferred embodiments of the invention will be described in reference to the accompanying drawings. These embodiments do not represent the full scope of the invention. Rather the invention may be employed in other embodiments. Reference should therefore be made to the claims herein for interpreting the breadth of the invention.

### BRIEF DESCRIPTION OF THE DRAWINGS

FIG. 1 is a front view of a prior ink fountain assembly;

FIG. 2 is a sectional end view along line 2-2 of FIG. 1;

FIG. 3 is a front view of an ink fountain assembly incorporating the present invention;

FIG. 4 is a sectional end view along line 4-4 of FIG. 3;

FIG. 5 is a front view of another embodiment of an ink fountain assembly incorporating the present invention;

FIG. 6 is a sectional end view along line 6-6 of FIG. 5; and

FIG. 7 is a sectional front view of another embodiment of an ink fountain assembly incorporating the present invention.

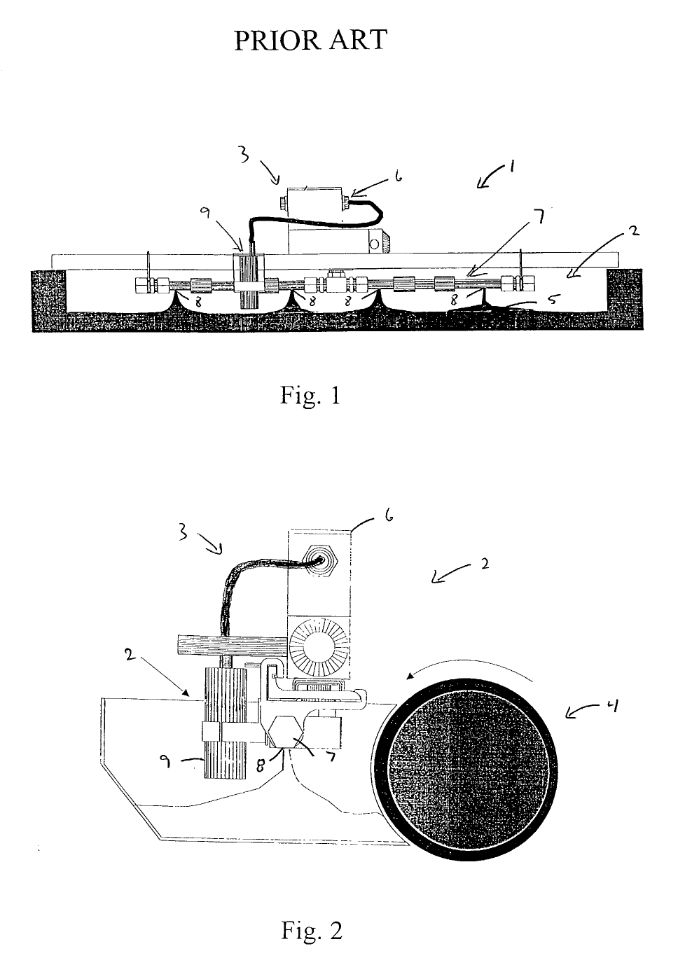

### DETAILED DESCRIPTION OF PREFERRED EMBODIMENTS

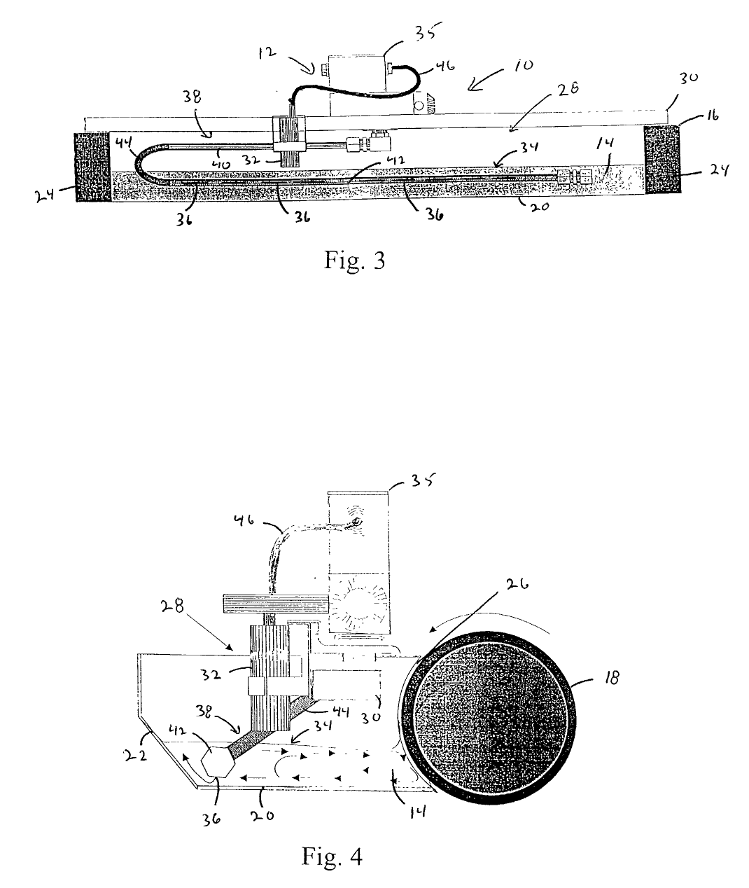

An ink fountain assembly 10 shown in FIGS. 3 and 4 forms part of a printing press which produces printed articles, includes an ink dispenser 12 which dispenses ink 14 into an ink fountain 16. The ink fountain 16 is in fluid communication with a fountain roller 18 which is coated by the ink 14. The fountain roller 18 receives the ink 14, and transfers it to one or more additional rollers (not shown) to supply the ink 14 to a printing plate (not The printing plate transfers an image from the printing plate to a blanket roller (not shown). The blanket roller transfers the image to a sheet of paper or other media to produce a printed article. Although the present invention is described in the context of a printing press having a series of rollers, the number and type of rollers is dependent upon the type of printing press and is not important to the present invention.

The ink fountain 16 is an elongated trough having a bottom wall 20 joined to a rear side wall 22 and trough ends 24 to form a reservoir for holding the ink 14. An open, front side 26 of the ink fountain 16 is blocked by the fountain roller 18 which rotates to draw the ink 14 from the reservoir. The top 28 of the ink fountain 16 is open, however, as discussed below, it can be closed to prevent contamination from above. A bracket 30 extending across the entire length of the ink fountain 16 over the top 28 supports the ink dispenser 12 and an ink level sensor 32. Although a ink fountain 16 having a bottom and rear wall is disclosed, the ink fountain 16 can be any shape known in the art, such as disclosed in U.S. Pat. Nos. 6,012,389 and 6,085,653, which has an angled bottom and no rear wall, without departing from the scope of the invention.

The ink 14 can be any fluid used in the art. Ink 14 disposed in the ink fountain 16 has a top surface 34 exposed to the ink fountain top 28. Preferably, prior to operation of the printing press, the ink fountain 16 is initially filled with ink 14 to a level at or above a minimum operating ink level which is defined below with respect to ink dispenser exit ports 36. During operation of the printing press, the ink dispenser 12 continues to dispense ink 14 into the ink fountain 16, as required, to maintain the ink top surface 34 above the minimum operating ink level. Preferably, the level of ink 14 in the ink fountain 16 is maintained above the minimum operating ink level, as required to provide a desired ink thickness on the fountain roller 18. Of course, the ink fountain assembly 10 can operate with an ink level below the minimum operating ink level, however, the benefits of the present invention will not be fully realized when operating in that mode.

The ink dispenser 12 is supported above the ink fountain 16 by the bracket 30, and includes an ink valve 35, such as an APV-3000 ink valve available from Link-Tech, Inc., Pewaukee, Wis. which is in fluid communication with a manifold 38. The ink valve 35 controls the flow of ink 14 through the manifold 38, and is coupled to the manifold 38 using methods known in the art, such as fluid couplings, hose, pipe, and the like.

The manifold 38 is a U-shaped assembly including an upper leg 40 and a submerged lower leg 42. Preferably, the upper leg 40 is a rigid tube fluidly connected to the ink valve 35, and supported above the ink 14 in the ink fountain 16. A flexible hose 44 fluidly connects the upper leg 40 to a lower leg 42 which is submerged below the top surface 34 of the ink 14. Advantageously, the flexible hose 44 simplifies installation of the manifold 38 in the ink fountain 16 by accommodating brackets positioned at different heights above the ink fountain bottom wall 20. The lower leg 42 of the manifold 38 is a rigid tube, and can be supported in the ink 14 from the bracket 20 or by the bottom wall 20. Although a manifold 38 having a pair of rigid tubes connected by a flexible hose is shown, the manifold 38 can be formed using methods and materials known in the art, such as all flexible tubing, all rigid pipe, couplings, and the like, without departing from the scope of the invention.

The ink 14 exits the manifold 38 into the ink fountain 16 through the exit ports 36 formed in the manifold lower leg 42. The exits ports 36 can be any shape, such as a nozzle, orifice, slit, and the like, which allows the ink 14 to exit the manifold lower leg 42 into the ink fountain 16. In the embodiment disclosed herein, a plurality of exit ports 36 are provided to evenly distribute the ink 14 along the entire length of the ink fountain 16. Although a plurality of exit ports 36 is disclosed, one or more exit ports 36, each in the form of a nozzle, orifice, elongated slot, and the like, can be provided depending upon the length of the ink fountain 16 and desired flow rate of ink 14 into the ink fountain 16 without departing from the scope of the invention. An exit port 36 in the shape of a slot extending along at least a portion of the length of the manifold lower leg 42 may be preferred in certain application because of the less likelihood of the slot becoming plugged from impurities in the ink.

Importantly, at least one exit port 36 is disposed below the ink top surface 34 in the ink fountain 16, such that ink is dispensed into the ink fountain 16 below ink top surface 34. Preferably, the submerged exit port 36 directs the ink 14 exiting the exit port 36 to circulate the ink 14 in the ink fountain 16 and discourage skin formation. Most preferably, the ink 14 is directed away from the ink top surface 34 and towards a rear edge of the ink fountain bottom wall 20 to circulate the ink 14, such that ink 14 disposed at the ink top surface 34 flows toward the fountain roller 18 to prevent the formation of a skin. Moreover, submerging all the exit ports 36 below the ink top surface 34 eliminates mounding caused by filling the ink fountain 16 from above.

Preferably, all of the exit ports 36 are submerged below the ink top surface 34 during operation of the printing press. However, only one submerged exit port 36 is required to circulate ink 14 in the ink fountain 16. As a result, the minimum operating ink level is defined as being the minimum level of ink 14 in the ink fountain 16 required to submerge at least one exit port 36 below the ink top surface 34.

As is known in the art, the weight of the ink 14 in the ink fountain 16, and thus the ink level in the ink fountain 16, affects the thickness of the ink 14 transferred to the fountain roller 18. Elimination of mounding on the ink surface provides a relatively level ink top surface 34 which can be accurately measured and varied to fine tune the thickness of ink 14 transferred to the fountain roller 18. In the embodiment disclosed herein, the ultrasonic ink level sensor 32 disposed above the ink top surface 34 measures the ink level. The sensor 32 is electrically connected to the ink valve 35, using a cable 46, or other methods known in the art, to accurately control the ink level in the ink fountain 16. Although an ultrasonic ink level sensor is disclosed, any ink level sensor 32, such as a float, tactile or mechanical sensor, pneumatic sensor, capacitance sensor, and like, can be used without departing from the scope of the invention.

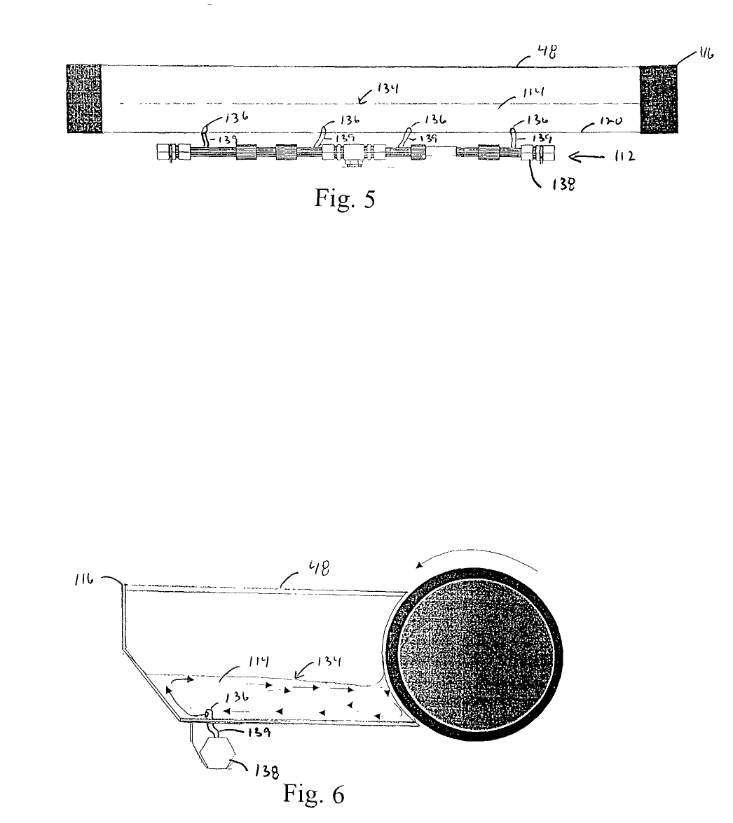

Advantageously, maintaining the exit ports 36 below the ink top surface 34 prevents the ink 14 from drying and clogging the exit ports 36. As a result, easy access to the manifold 38 to clear out clogged ports 36 is not required. Therefore, a cover 48 closing the open ink fountain top 28, such as disclosed in FIGS. 5 and 6, can be provided to prevent contaminants, such as dust, paper, water, and the like, from falling into the ink 14.

In use, the ink fountain 16 is initially filled with ink 14 to a desired maximum ink level above the minimum operating ink level by pumping ink 14 through the ink valve 35, manifold 38, and out of the manifold exit ports 36. Once the ink 14 reaches the desired maximum ink level in the ink fountain 16, the ink valve 35 closes to stop the flow of ink 14 into the ink fountain 16. During the operation of the printing press, as the ink 14 is drawn out of the ink fountain 16 by the fountain roller 18, and the ink level drops below a desired minimum ink level, the ink level sensor 32 provides a signal to the ink valve 35, either directly as shown herein, or through a microprocessor or other control unit, to open the valve 35 to raise the ink level to the desired maximum ink level by allowing ink 14 to flow through the manifold 38 and out of the exit ports 36 into the ink fountain 16.

Ink 14 flowing out of the exit ports 36 into the ink fountain 16 is directed by the exit ports 36 to circulate the ink 14 in the ink fountain 16. The circulating ink 14 causes the ink 14 at the ink top surface 34 to flow toward the roller fountain 18, and thus prevent the formation of a skin. Moreover, as discussed above, ink 14 exiting the manifold exit ports 36 below the ink top surface 34 does not mound to provide a relatively level ink top surface 34 which can be sensed by the ink level sensor 32 to accurately determine the ink level in the ink fountain 16. By accurately sensing the ink level, the difference between the desired minimum and maximum ink levels can be small to fine tune the thickness of ink 14 transferred to the fountain roller 18.

In another embodiment disclosed in FIGS. 5 and 6, the ink dispenser 112 includes a manifold 138 disposed beneath the ink fountain 116. Manifold exit ports 136 extend through holes formed in the bottom wall 120 of the ink fountain 116, and are in fluid communication with the manifold 138 using flexible tubing 139. Each exit port 136 directs the ink 114 toward the rear edge of the ink fountain bottom wall 120 to circulate the ink 114 in the ink fountain 116. Advantageously, in this embodiment, the manifold 138 is located outside of the ink fountain 16, and only the exit ports 136 are submerged in the ink 114 below the ink top surface 134. In this embodiment, the ink 114 can be supplied to the manifold 138 through an ink valve, such as described above. In addition, an ink level sensor, such as disclosed above, can also be provided beneath the cover 48 to provide the same ink level control advantages as described above.

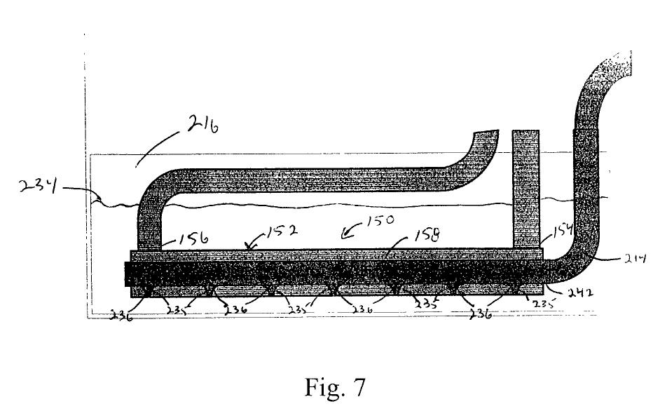

Certain inks used in printing presses must be applied to the printed media at a preferred temperature to ensure the ink has a high viscosity. In yet another embodiment shown in FIG. 7, a cooling member 150 in the form of a cooling jacket 152 wrapped around at least a portion of the manifold lower leg 242 is in thermal communication with the ink 214 in the ink fountain 216 and the ink 215 being dispensed into the fountain 216. The cooling member 150 maintains the dispensed ink 215 at a desired temperature. Advantageously, the ink 214 being dispensed can be maintained above a desired printing temperature during storage and distribution, and then cooled to the desired printing temperature when dispensed into the ink fountain 216. Maintaining the undispensed ink 214 above a desired printing temperature reduces the viscosity of the ink 214 during distribution of the ink 214 to the printing press. The lower viscosity of the ink 214 reduces the cost to pump the ink 214 from the storage reservoir to the printing press, and may minimize clogging of the exit ports 236.

Preferably, the cooling jacket 152 is sealingly wrapped around a portion of the manifold lower leg 242 submerged below the ink top surface 234, and includes an inlet 154 and outlet 156. Nozzles 235 formed in the jacket 152 shown in FIG. 7 are in fluid communication with the manifold exit ports 236 to direct the flow of ink 214 into the ink fountain 216. Of course, the jacket can be formed to conform to any shaped exit port, such as the shapes disclosed above. For example, if the ink exits the manifold through a single slot formed in the manifold lower leg, the jacket can be formed to have a slot or other shaped passageway in fluid communication with the manifold slot to cool the ink as it exits the manifold.

Cooling fluid 158, such as chilled water, and the like, enters the jacket 152 through the inlet 154 and exits the jacket 152 through the outlet 156. Advantageously, in addition to cooling the undispensed ink 214 as it is dispensed into the ink fountain 216, the submerged cooling jacket 152 maintains the dispensed ink 215 in the ink fountain 216 at the desired temperature. The cooling fluid 158 can be circulated through the jacket 152 using a pump, as is known in the art. Although a cooling jacket wrapped around at least a portion of the manifold lower leg is preferred, the cooling member can be submerged in the ink in the ink fountain to cool the ink independent of the manifold lower leg without departing from the scope of the invention. Of course, the cooling member 150 can also be used to warm the ink 214, 215 if the temperature of the dispensed ink 215 and/or undispensed ink 214 is below the desired temperature by circulating cooling fluid 158 through the jacket 152 which has a temperature that is above the temperature of the dispensed ink 215 and/or undispensed ink 214.

While there has been shown and described what are at present considered the preferred embodiments of the invention, it will be obvious to those skilled in the art that various changes and modifications can be made therein without departing from the scope of the invention defined by the appended claims. For example, the manifold, or exit port, can extend into the ink fountain through an ink fountain end wall rather than the top or bottom wall to submerge the exit port beneath the top surface of the ink. In addition, a prior art manifold can be modified, such as by attaching tubes to the exit ports, to extend the exit ports below the ink top surface without relocating the manifold.

I claim:

1. An ink fountain assembly comprising:
an ink fountain for receiving ink, said ink fountain being in fluid communication with a fountain roller;
an ink dispenser for dispensing ink into said ink fountain, said ink dispenser having at least one exit port disposed below a minimum operating ink level, said minimum operating ink level being the minimum ink level in said ink fountain necessary to submerge said at least one exit port in the ink, wherein ink exits said ink dispenser through said at least one exit port into said ink fountain.

2. The assembly as in claim 1, in which said ink fountain includes a forward side, and said ink fountain is in fluid communication with the fountain roller proximal said forward side, and said at least one exit port directs ink exiting said at least one exit port away from said forward side to circulate the ink in said ink fountain.

3. The assembly as in claim 1, in which said ink dispenser is a manifold having at least one exit port formed therein in, and at least a portion of said manifold including said at least one exit port is disposed below said ink level.

4. The assembly as in claim 1, in which said ink fountain has an open top, and a cover covers said top.

5. The assembly as in claim 1, in which an ink level sensing device senses the level of ink in said ink fountain.

6. The assembly as in claim 5, in which said ink dispenser includes a control valve, that controls the flow of ink through said at least one exit port, and said ink level sensing device provides a signal which causes said control valve to open and close in response to predetermined ink levels in said ink fountain to maintain the level of said ink disposed in said ink fountain within a predetermined range.

7. The assembly as in claim 1, in which said at least one exit port is a slot.

8. The assembly as in claim 1, in which a cooling member is in thermal communication with the ink in said ink fountain.

9. The assembly as in claim 1, in which said cooling member is wrapped around at least a portion of said ink dispenser proximal said at lest one exit port disposed below the minimum ink level.

10. A method of dispensing ink in an ink fountain containing ink having a top surface, said method comprising:
dispensing ink into the ink fountain below the top surface of the ink disposed in said ink fountain.

12. The method of dispensing ink as in claim 10, in which said ink is dispensed in a direction away from said ink top surface to circulate the ink disposed in said ink fountain.

13. The method of dispensing ink as in claim 10, in which said ink is dispensed in a direction to circulate ink proximal said ink surface toward a fountain roller receiving the ink from said ink fountain.

14. The method of dispensing ink as in claim 10, including monitoring said ink top surface, and dispensing said ink when said ink top surface is below a predetermined ink level.

15. The method of dispensing ink as in claim 10, including cooling said ink dispensed into said ink fountain.

16. The method of dispensing ink as in claim 15, in which said ink is cooled as said ink is dispensed into said ink fountain.

17. An ink fountain assembly comprising:
an ink fountain for receiving ink, said ink fountain being in fluid communication with a fountain roller;
a cooling member extending into said ink fountain for maintaining ink disposed in said fountain within a predetermined temperature range.

18. The assembly as claim 17, including an ink dispenser for dispensing ink into said ink fountain, said ink dispenser having at least one exit port disposed below a minimum operating ink level, said minimum operating ink level being the minimum ink level in said ink fountain necessary to submerge said at least one exit port in the ink, wherein ink exits said ink dispenser through said at least one exit port into said ink fountain.

19. The assembly as in claim 18, in which said ink fountain includes a forward side, and said ink fountain is in fluid communication with the fountain roller proximal said forward side, and said at least one exit port directs ink exiting said at least one exit port away from said forward side to circulate the ink in said ink fountain.

20. The assembly as in claim 18, in which said ink dispenser is a manifold having at least one exit port formed therein in, and at least a portion of said manifold including said at least one exit port is disposed below said ink level.

21. The assembly as in claim 17, in which said cooling member is wrapped around at least a portion of said ink dispenser proximal said at least one exit port disposed below the minimum ink level.

22. The assembly as in claim 18, in which said at least one exit port is a slot.
